(19) United States
(12) Patent Application Publication
(10) Pub. No.: US 2014/0132521 A1
(43) Pub. Date: May 15, 2014

(54) Keyboard input system via hand motion detection and recognition of the printed locations of the keys on a flat surface using a video camera and range imaging device.

(71) Applicant: Evan Shellshear, (US)

(72) Inventor: Evan Shellshear, (US)

(21) Appl. No.: 14/103,293

(22) Filed: Dec. 11, 2013

(51) Int. Cl. G06F 3/02

(52) U.S. Cl. CPC G06F 3/02
USPC 345/168

(57) ABSTRACT

A keyboard printed on a flat surface and its use facilitated only by a single video camera and range imaging device is presented. The detection of the pressing of a key is accomplished via the combined use of the video camera and range imaging device as well as the correct communication between them and editing of the range image data. In addition, the use of a video camera allows the keyboard be moved while in use thanks to the existence of an additional fiducial marker printed on the flat surface. The keyboard can also be given an arbitrary shape, layout and key design and is not restricted to be printed on any one type of flat surface.

### INVENTION

As computer devices become smaller and smaller ways of being able to provide input to such devices become more difficult. The use of touch screen devices, whereby a keyboard presented on the screen blocks a portion of the screen, are demanding innovative solutions for users to be able to easily input information from a keyboard without using screen space or overburdening the device's computational powers. Keyboards, if they are not to be a part of the screen, are required to fulfill demanding criteria to be useful for such small, battery and processing power constrained computer devices. Examples of constraints on an external keyboard are that it should drain minimal or no energy from the computer device (due to such devices having limited battery capacity), it should be movable with the device and not fixed in one place, and preferably it should present the user with an interface similar to one already known to the user. Another desirable criterion is to allow the user to customize the keyboard to the user's needs. The current invention, as characterized by claim 1, proposes a solution that fulfills the aforementioned criteria. The criteria are fulfilled by providing the user with a keyboard that by itself does not require any power source (the video camera technology used to provide the keyboard's functionality is now common in laptops, tablets, and mobile phones and, in addition, range imaging devices have become small enough to drain very little energy from the devices they are attached to, e.g., Leap Motion, http://www.leapmotion.com). In addition, the invention, as characterized by claim 1, imposes minimal restrictions on the user's movement, the only one being that the fiducial marker and the user's fingers are visible to the video camera and range imaging device. Such a restriction is very natural because it is normally fulfilled by the user being positioned in front the computer device they are using. This restriction, however, does not restrict the positioning of the range imaging device and the video camera. The only restriction on the range imaging device and the camera is that they be located on the same side of the printed keyboard and both be faced towards it. The keyboard can also be customized (e.g. other languages, different key positions, etc.) by merely printing out a different layout of the keys with a different code stored in the fiducial marker so that pressing a key is mapped to a different symbol by the computer device. Finally the keyboard can also be printed on softer materials, such as cardboard, to avoid the user the pain of pressing on a hard surface.

### OTHER KNOWN TECHNOLOGIES

Examples such as virtual projection keyboards (U.S. Pat. Nos. 7,307,661, 6,611,253, 6,690,357 and 6,911,972) and keyboards with variable keys (U.S. Pat. Nos. 5,818,361 and 6,611,253) provide similar functionalities but are not necessarily as flexible as a keyboard that can simply be printed on a piece of paper such that the user can simply swap the piece of paper when the user wishes to change keyboard layouts. Besides, the invention, as characterized by claim 1, does not require a flat, non-reflective surface to project the image of the keyboard onto. Such surfaces can often cause pain to the user's fingers after prolonged use and also restrict the places where such a device can be used.

In addition, for virtual or physical keyboards that rely only on a camera to track the fingers, the use of them often requires additional markers on the fingers or special backgrounds so that the camera can differentiate the fingers from the surrounding environment (U.S. Pat. No. 5,767,842). The invention, as characterized by claim 1, avoids such extra requirements.

As disclosed in U.S. Pat. No. 6,803,906, a device comprising two video cameras and serving a similar purpose is presented, however, using the invention disclosed in U.S. Pat. No. 6,803,906 requires the video cameras to have overlapping fields of view, to be located in different locations and is only designed for the tracking of a single object. The current invention, as characterized by claim 1, does not require the video camera and range imaging device to have overlapping fields of view. In addition, the video camera and range imaging device can also be located in the same device which is becoming quite common (e.g. SoftKinetic Senz3D™, Microsoft Kinect®, etc) unlike two video cameras as required in U.S. Pat. No. 6,803,806.

### DESCRIPTION OF THE FIGURES

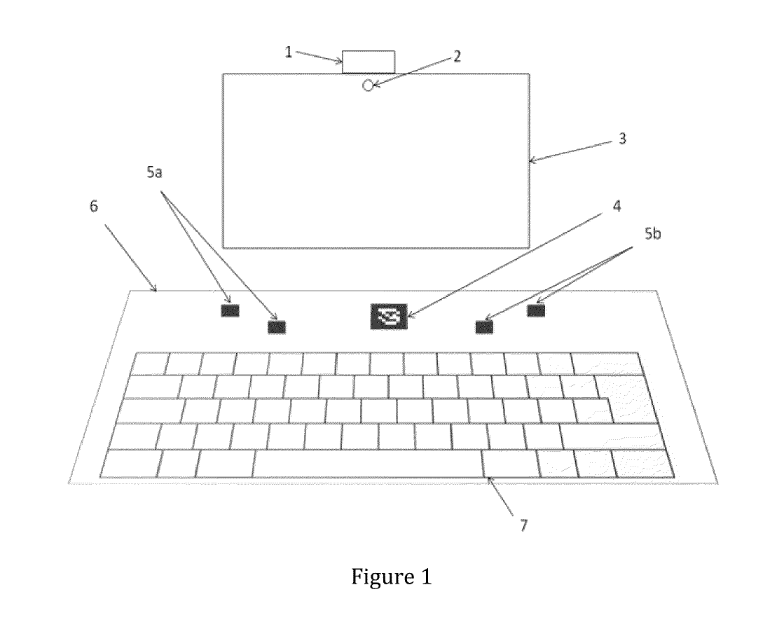

In FIG. 1 one can see the positioning of the range imaging device (1) and camera (2) in front of the keyboard (7), which is printed on a flat surface (6). Although not part of the invention, for ease of interpretation, the position of the user's screen (3) is placed in front of the keyboard as the device could be used in practice. The camera (2) is shown built into the frame of the screen as is typical for current laptops and tablet computers. The fiducial marker (4) is located between the keyboard and the camera so that the user's fingers do not block the camera's view of it. The marks (5a) and (5b) show where the fingers are to be placed initially to calibrate the range imaging device and video camera with each other, if this is necessary.

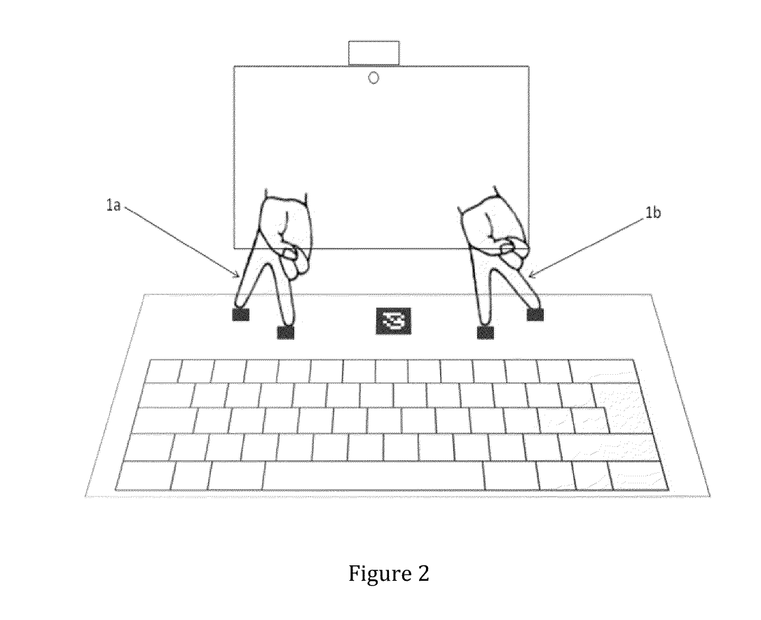

In FIG. 2 one sees the user calibrating the devices with the fingers of the user's hand (1a) and (1b) located on top of the calibrating marks ((5a) and (5b) in FIG. 1).

### DETAILED DESCRIPTION OF INVENTION

According to one aspect of the present invention there are 3 main parts, as presented in claim 1, comprising:
a flat surface with one or more specific markers and keyboard (or similar) layout printed on it
a single video camera
a device capable of accurately capturing the position of fingers in three dimensions (3D) such as a range imaging device.

The layout of the devices is presented in FIG. 1 so that the camera (2) and range imaging device (1) can see the keyboard (7) (on top of which the user's fingers will be located while typing).

In a preferred embodiment, the invention works by putting a marker on the flat object, e.g. a fiducial marker, which the video camera can detect. The fiducial marker stores information about the layout of the printed keys on the flat surface by providing a code (associated with the fiducial marker's unique pattern) for a keyboard layout stored on the computer device. In addition, while detecting the position of the fiducial marker, information about the orientation and location of the flat surface can be derived. The fiducial marker is located on the paper between the printed keyboard and the video camera so that while the user is using the keyboard, the user's hands do not block the view of the fiducial marker from the video camera.

The range imaging device detects the movements of the fingers, however, to be able to interact with the keyboard, the position and orientation of the flat surface that the keyboard is located on must be communicated to the range imaging device. This is necessary so that when a finger moves in a given direction, the range imaging device can compute whether the finger is approaching the keyboard or not and where on the keyboard the finger is located. To be able to accomplish the communication between the range imaging device and the camera, the two devices need to know the transformation between each input device's coordinate system. If this is not initially known, then this can easily be achieved as shown in FIG. 1, where a fiducial marker is placed at the top of the flat object and, in one embodiment of the device, four additional distinguishing marks are printed on the surface near it. Note that printing these marks separate to the keys of the keyboard is not necessary, this has merely been done here for clarity and one could easily use extant keys of the keyboard. To calibrate the camera and range imaging device, the user places four of the user's fingers (or similar object) on the marks while holding the flat surface in front of the camera and range imaging device. The transformation to go between the two devices can then be computed via the computer device attached to the video camera and range imaging device. The computation amounts to computing a rotation and translation between the two 3D coordinate systems and this can be achieved by locating four common points in both coordinate systems and computing the transformation between them. This calibration is done once for fixed relative positions of the video camera and range imaging device. If one moves one of the devices independent of the other, then the user needs to recalibrate the devices.

In addition to finding the transformation to go between cameras, one also needs to transform coordinates from one system to the other. This can be achieved by a so-called UV map that takes the pixel coordinates and can transform them to the positions in the range imaging device's 3D image. This depends on the two devices in question and can be easily computed.

The final step to be carried out is necessary for the current generation of finger tracking software. Currently finger tracking software requires the fingers and the background to be separated by a significant distance (currently more than approximately 10 cm) to be able to track the fingers accurately. With the current invention, the fingers will often be located on the paper or just above, hence current algorithms will not work properly in this scenario. To overcome this, we use the known position of the keyboard (see previous paragraph) to find out what distance the keyboard should have from the range image device. We then check the range image device's 3D image to see the actual distances and set all values in the area of the keyboard that are at a distance equal to the keyboard's distance from the range imaging device to some default value. If the distance is not equal to the distance that the keyboard should be located at then we leave the distance value as it is. This can then be used to make the entire keyboard “disappear” so that all that remains are the distance values of the hand if it is located in front of the keyboard. Standard software can then successfully compute the locations of the fingers which are then used to detect when a finger presses a key as outlined in the next paragraph.

The range imaging device detects where the fingers are located and the camera knows where the additional printed keys are based on the information stored in the fiducial marker. As the user moves the keyboard the camera tracks the fiducial marker and continually recomputes the new orientation and position of the flat surface. At the same time this information is sent to the range imaging device which tracks the user's fingers' location. Then the range imaging device, with suitable software algorithms, is able to compute whether and how the fingers are interacting with the keyboard based on their positions and velocities. In one embodiment of the device, good usability was found by defining a key press when a downward moving finger came within 2 mm of the printed keyboard. After computing which key the finger would strike on the keyboard, it was then decided whether the user did a single key stroke based on whether the finger then retracted from the keyboard. If the finger remained on the key, after the downward motion, it was decided that the key was being continually pressed.

The keyboard can also be customized by allowing the user to choose the positions and types of keys present on the keyboard. The user can define and create any positions for the keys to be printed on the flat surface as well as the symbols on the keys themselves. The information regarding the layout and key types are retrieved by the computing device and, as mentioned before, the fiducial marker provides the computing device with the information to know which layout of keys and symbols is to be used. This provides the user with the ability to have keyboards for any language or set of symbols with custom sized keyboards (e.g. printed out on different sizes of paper or different sizes on a single piece of paper), custom color schemes, custom key positions, custom markings on the keys (e.g. Braille markings for blind users), custom buttons with special functions and other additional capabilities such as defining an area so that the user's finger motions can be interpreted as controlling a mouse and clicking its buttons (emulating the mouse pads located on laptops, etc.).

1. A keyboard printed (via ink or similar) on a flat surface and its use facilitated by a single video camera and a range imaging device.

2. A keyboard according to claim 1 with an arbitrary layout of keys printed on the flat surface with the keyboard being of any size or orientation.

3. A keyboard according to claim 1 with any symbols (based on a real or invented language or purpose) printed on the keys and interpreted so by the computer device with which the keyboard is used.

4. A keyboard according to claim 1 whereby the keyboard is printed with other materials other than ink on a flat surface so that a video camera can recognize the fiducial marker printed in that material.

5. A keyboard according to claim 1 whereby the keyboard's keys are not printed on the flat surface but are added by some other process and may be made out of any material that can be placed or positioned in a single position during usage on the flat surface.

6. A keyboard according to claim 1 whereby the fiducial marker is replaced by a similar object serving the same purpose.

7. A keyboard according to claim 1 whereby the fingers are tracked using a device different to a standard range imaging device.

8. A keyboard according to claim 1 whereby the calibrating markings are placed anywhere on the paper or are actual keys of the keyboard itself.

9. A keyboard according to claim 1 whereby the flat surface is made out of any material such that the material itself is not necessarily flat but can be made so when used as the keyboard.

10. A keyboard according to claim 1 whereby a device other than a video camera is used to detect the fiducial marker.

11. A keyboard according to claim 1 whereby the range imaging device and video camera are located in any arbitrary positions on the same side of the flat surface as the printed keyboard.

12. A keyboard according to claim 1 whereby the range imaging device and video camera are combined into a single device so that the calibration of the transformations between the devices is not necessary.

13. A keyboard according to claim 1 whereby it is not necessary to map coordinates between the video camera and range image device via a UV map.

14. A keyboard according to claim 1 whereby the device is sensitive enough so that it is not necessary to set the range imaging device's distance values of the keyboard equal to some default value so that the fingers can be tracked.

15. A keyboard according to claim 1 which also contains an area for controlling a mouse or similar device on a computer.

16. A keyboard according to claim 1 which is used as an input to a computer or similar device such that the keyboard does not serve the purpose of a normal computer keyboard but provides input of some other fashion to the computer device.

17. A keyboard according to claim 1 that provides input to something other than a computer or similar device.

18. A keyboard according to claim 1 whereby the user's fingers do not interact with the device but other objects are used that can be tracked by the range imaging device.
